(19) United States
(12) Patent Application Publication
(10) Pub. No.: US 2005/0178841 A1
(43) Pub. Date: Aug. 18, 2005

(54) System and methods for product and document authentication

(76) Inventors: Guilford Jones II, Canton, MA (US); Shawn Burke, Andover, MA (US); Peter McDonald, Natick, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/517,299

(22) PCT Filed: Jun. 7, 2002
(86) PCT No.: PCT/US02/17866

(51) Int. Cl. G06K 7/10; G06K 19/06

(52) U.S. Cl. 235/468; 235/491

(57) ABSTRACT

The present invention relates to both a system and method for product and document authentication. The system used herein comprises one or more inks, at least one of which is either invisible to the naked eye or is fluorescent or luminescent, an optical (2, 3, 8) scanning component capable of detecting the signals emitted by all of said inks, and an information technology component for analyzing said signals. Given the large number of combinations of dyes, sizes and shapes of the markings made with said dyes, the ability to change the type, size and shape for the marking (5) for a given product, and the ability to keep track of the dyes and markings used for a given product, the system allows a nearly foolproof system for product authentication. The method involves the above system, or other combinations of inks, for authenticating a given product.

### CROSS REFERENCE TO RELATED APPLICATIONS

This application is a continuation-in-part of U.S. patent application Ser. No. 09/354,891, filed Jul. 16, 1999, which is incorporated in its entirety herein.

### STATEMENT REGARDING FEDERALLY SPONSORED RESEARCH OR DEVELOPMENT

N/A

### BACKGROUND OF THE INVENTION

Accurate verification of products and documents is critical to a wide variety of industries including the manufacture of pharmaceuticals, clothing, or automotive parts, and the issuance of credit and identification cards or travel/immigration documentation. Counterfeiters of products, currency and documents have developed increasingly sophisticated methods of detection and copying of marks and labels. Counterfeiting and diversion cost owners of products, brand names, and intellectual property billions of dollars annually on a world-wide basis, according to the International Anti-Counterfeiting Council (IACC). The problem in the United States, for example, encompasses an estimated loss in revenues of $ 200 billion per year, as well as associated costs in tax revenues and the loss of jobs.

Current technologies used to detect counterfeit, diverted, or gray market products include a variety of techniques. The recently published volume, “Optical Security Documents”, 2nd ed. (Ed., E. L. van Renesse, Artech House, Boston, 1998) describes methods in detail that employ security printing, holograms, optically variable devices, and thin film security devices. A popular choice that remains among these techniques is markings with holograms. In most applications, these features are not covert; moreover, methods have been developed that reproduce holograms with remarkable accuracy. A preferred method in controlling inventory or personal access systems is the bar code. This familiar methodology produces black and white line images that incorporate an alphanumeric code; techniques for applications and encryption of bar codes are increasingly sophisticated and include multi-layering, 1-D and 2-D imaging, and other features.

A number of U.S. patents have been issued that describe the use of luminescent materials for product or document identification. (U.S. Pat. No. 4,921,280, M. Jalon, Security Fibers and other Materials Made Luminescent by a Dyeing Process, Process for their Manufacture and Their Applications; U.S. Pat. No. 4,874,188, G. Philippe, et al., Fiduciary or Security Object Enabling Visual or Optical Authentication; U.S. Pat. No. 5,135,569, E. Mathias, Ink Composition Containing Fluorescence Component and Method of Tagging Articles Therewith; U.S. Pat. No. 5,461,136, J. Krutak, et al., Method for Tagging Thermoplastic Materials with Near-infrared Fluorophores; U.S. Pat. No. 5,525,516, J. Krutak, et al., Method for Tagging Petroleum Products) Of particular relevance to the present invention is prior art in which bar codes are enabled for security purposes using luminescent invisible inks. (U.S. Pat. No. 5,542,971, J. D. Auslander and W. Berson, Bar Codes Using Luminescent Invisible Inks; U.S. Pat. No. 5,502,304, W. Berson and J. D. Auslander, Bar Code Scanner for Reading a Visible Ink and a Luminescent Invisible Ink and U.S. Pat. No. 5,525,798, W. Berson and J. D. Auslander, Bar Code Scanner for Reading a Lower Layer Luminescent Invisible Ink that is Printed below an Upper Layer Luminescent Invisible Ink) Specific use of lanthanide chelates as security marking is taught in U.S. Pat. No. 5,837,042 (B. A. Lent, et al., Invisible Fluorescent Jet Ink), a patent in which lanthanide chelates comprised of the ligands of the 1,3-diketone class or salicylic acid are utilized in ink jet printing applications that feature covert marking.

Unlike most other luminescent organic or organometallic compounds whose lifetime for spontaneous emission (fluorescence) appears commonly in the 1-30 nanosecond range (corresponding to the time required for signal decay to 1/e, for single exponential decays), the lanthanide chelates display luminescence that is measured in the 0.1-5.0 millisecond (ms) time domain. These measurements are carried out using time-resolved emission techniques in which a pulsed source of light is used to excite a sample (J. N. Demas, Excited State Lifetime Measurements, Academic Press, New York, 1983).

The capabilities of rare earth chelates to produce bright luminescence that displays a long decay time have been chiefly exploited in the assay of biological macromolecules. For example, the tagging of antigen or antibody components with chelating ligands in fluorescence immunoassay is now well established (e.g., the EALL techniques, or enzyme-amplified lanthanide luminescence—R. A. Evangelista, et al., Analytical Biochemistry, 197, 213 (1991)). The principal advantage associated with lifetime measurement lies in the ready discrimination of the millisecond luminescence of chelates from the nanosecond fluorescence associated with background emission which is native to the labeled biomolecule. This method of recording luminescence intensity at different time intervals following photoexcitation of a sample has been demonstrated using a time-resolved fluorimeter or a system having a laser source and photon-counting or other means of detection (U.S. Pat. No. 5,854,008, E. P. Diamandis, Europium and Terbium Chelators for the Time-Resolved Fluorometric Assays; T. K. Christopoulos and E. P. Diamandis, Analytical Chemistry, 64, 342 (1992)).

A number of U.S. patents have also appeared that use luminescence decay time as a measure of a physical or environmental parameter (principally temperature). In this methodology, luminescent materials such as chromium-doped crystals or metal phosphors are used, along with detectors which, for example, are comprised of a video camera, timing circuits, and a CCD array. (U.S. Pat. No. 5,600,147, E. M. Jensen, Temperature Measuring System Having Improved Signal Processing and Multiple Optical Sensors; U.S. Pat. No. 5,414,266, M. H. Sun, Measuring System Employing a Luminescent Sensor and Methods of Designing the System; U.S. Pat. No. 5,304,809, K. A. Wickersheim, Luminescent Decay Time Measurements by Use of a CCD Camera; U.S. Pat. No. 5,107,445, E. M. Jensen, et al., Modular Luminescence-based Measuring System Using Fast Digital Signal Processing).

In the field of security bar coding, lanthanide chelate luminescence has been employed, along with scanning devices capable of distinguishing long-lived luminescence have also been reported. (U.S. Pat. No. 5,542,971, J. D. Auslander and W. Berson, Bar Codes Using Luminescent Invisible Inks; U.S. Pat. No. 5,693,693, J. D. Auslander and W. Berson, Bar Code Printing and Scanning Using Wax-based Invisible Fluorescent Inks) A recent patent describes a method in which light signals from a luminescent bar code layer doped with a phosphorescent ink are distinguished, based on time resolution, from the faster decay of fluorescent light emanating from a conventional film layer (U.S. Pat. No. 5,861,618, W. Berson, System and Method of Improving the Signal to Noise Ratio of Bar Code and Indicia Scanners that Utilize Fluorescent Inks).

### BRIEF SUMMARY OF THE INVENTION

The present invention relates to both a system and method for product authentication. The system used herein comprises (1) one or more dyes or pigments, at least one of which is either invisible to the naked eye or is fluorescent or luminescent, (2) an optical component capable of detecting the signals emitted by all of said inks, and (3) an information technology component for analyzing said signals. There are a large number of combinations of (1) dyes or pigments, (2) sizes and shapes of the markings made with said dyes, (3) the ability to change the type, size and shape for the marking for a given product, and (4) the ability to keep track of the dyes and markings used for a given product. With these features the system allows a nearly foolproof method for product authentication. The method employs the above scanning and information technology components, along with the above dyes or other combinations of dyes, for authenticating a given product.

### BRIEF DESCRIPTION OF THE DRAWINGS

FIG. 1 shows typical chromophores used in an ink or tag, said chromophores being europium chelates. (Chemical structures of ligands are illustrated; it is assumed that actual structures are tris-chelates in which three ligands are bound to metal.)

FIG. 2 shows examples of a ytterbium chelate and ultraviolet and blue-violet emitters.

FIG. 3 shows ‘charge transfer’ modifications to ligands that control chelate absorption (e.g., shifts to longer wavelengths in the near UV).

FIG. 4 shows the digital capture of an invisible barcode temporal decay time.

FIG. 5 shows the spectra for a product which is marked with both terbium (a) and europium (b) chelates.

FIG. 6 shows the typical profiles of excitation and decay of luminescent dyes used in this invention.

FIG. 7 shows a schematic of a lifetime imaging detector.

FIG. 8 shows a schematic of mark variations, including selections for variable data, authentication signatures, and spatial arrangements.

FIG. 9 shows the overall system operational steps (A), after excitation and decay of a dye sample and the verification pathways or modules for authentication and reading of variable data (B).

FIG. 10 shows system data collection, routing and transmission modes.

FIG. 11 shows a block diagram of the overall system including mark illumination, detection and data transmission.

FIG. 12 shows an illustration of an on-line reader for reading authentication of variable data signatures and data transmission capability.

FIG. 13 shows a block diagram of a generic two-channel detection device covered by this invention.

FIG. 14 shows a sequence of luminescence spectra and recorded lifetimes during the course of heat treatment for two europium chelates (I and II), one of which is heat labile and one relatively heat-stable. The times range from 0.45 (spectrum a) through 1.12 (spectrum d) milliseconds in the heat treatment process.

FIG. 15 shows luminescence spectra for two near-infrared dyes recorded before (solid lines) and after (dashed lines) irradiation treatment using a Xenon lamp.

### DETAILED DESCRIPTION OF THE INVENTION

A system for product authentication is described that integrates unique luminescent or fluorescent tags (also referred to as taggants) with an optical scanning system and information technologies. (These tags are otherwise referred to as dyes, pigments, inks, marks, or labels elsewhere in this application.) Some tags are the subject of a pending patent application (U.S. Ser. No. 09/354,891, filed Jul. 16, 1999, hereafter referred to as '891), which is incorporated herein in its entirety. This application relates in part to the other components, namely the scanner and the information system, and the incorporation of these components along with the tags to constitute a product or document authentication system. The use of any dye, not solely the above dyes, along with a scanner and information system, constitutes a method for product authentication.

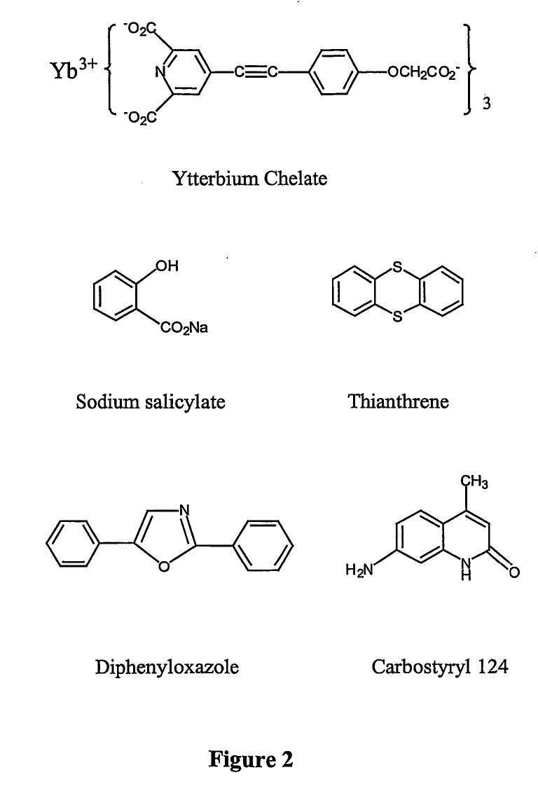

In addition, other tags and spatial features of the tags are proposed that increase the number of unique tags that can be created with these luminescent materials. The later examples are designed to add another level of protection for covert marking of products or documents. Examples included have the property that neither their excitation spectra nor their luminescence is observable, or at best very faintly observable, by the human eye. These examples are meant to encompass classes of chromophores such as the rare earths that emit in the near-infrared (e.g., chelates that are based on ytterbium (971 nm) and neodymium (1064 nm). A chelate derivative of ytterbium (3+oxidation state) is shown in FIG. 2. Also useful in this context are chromophores that absorb in the ultraviolet, which emit at very short wavelengths, sometimes also in the ultraviolet. The latter classes of chromophores include aromatic hydrocarbons, oligophenylenes, conjugated polyenes or stilbene derivatives, coumarins, furans, quinolones, oxazoles, and thianthrenes (M. Maeda, Laser Dyes, Academic Press, New York, 1984). These groups of compounds display relatively high quantum yields of fluorescence with light emission in the wavelength range of 350-450 nm, and fluorescence lifetimes that fall in the range of 1-50 nanoseconds. Other compounds that show utility for covert marking and lifetime imaging, representing the latter classes of structures include 1,5-diphenyloxazole and thianthrene (FIG. 2).

Several possible embodiments of the optical scanning system and its subsystems/components are described. The scanner will provide an indication to the user as to (1) whether it detects a tag; and (2) whether or not a detected tag is authentic. By linking the scanner to a database system—or otherwise incorporating such a capability into the scanner itself—this authentication will be based upon the most up-to-date information regarding the tag(s) in use. Further, the authentication can be linked to an inventory control and management system, providing even greater benefit to the user.

Some features of the dyes used herein will be briefly discussed herein, although '891 should be referred to for additional information. The design of the ligand chromophores for rare earth chelates has been limited historically to the basic requirements of UV absorption (improved light harvesting) and ligand-metal excited state energy matching. We demonstrate in '891 that ligands having a particular assembly of substituent groups can be used in a predictable way in order to act as more effective sensitizing agents.

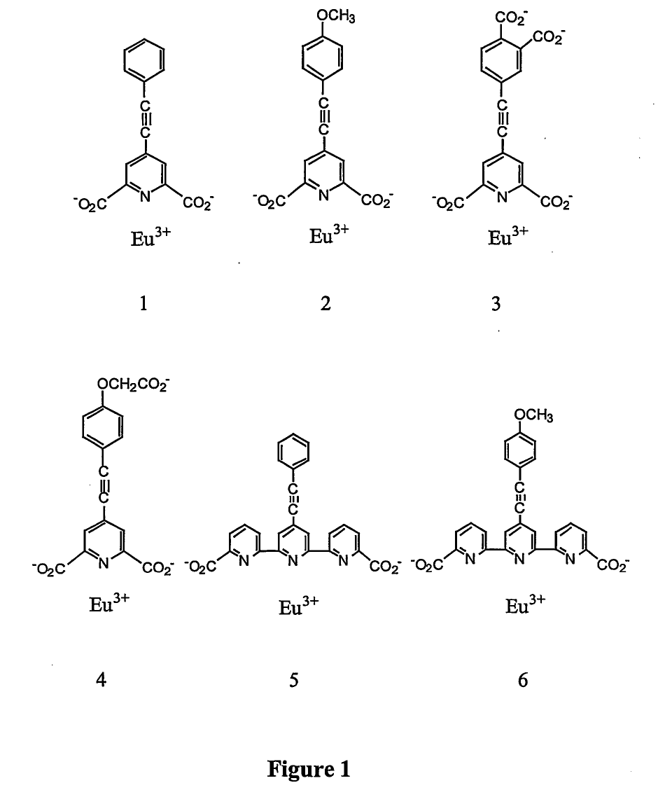

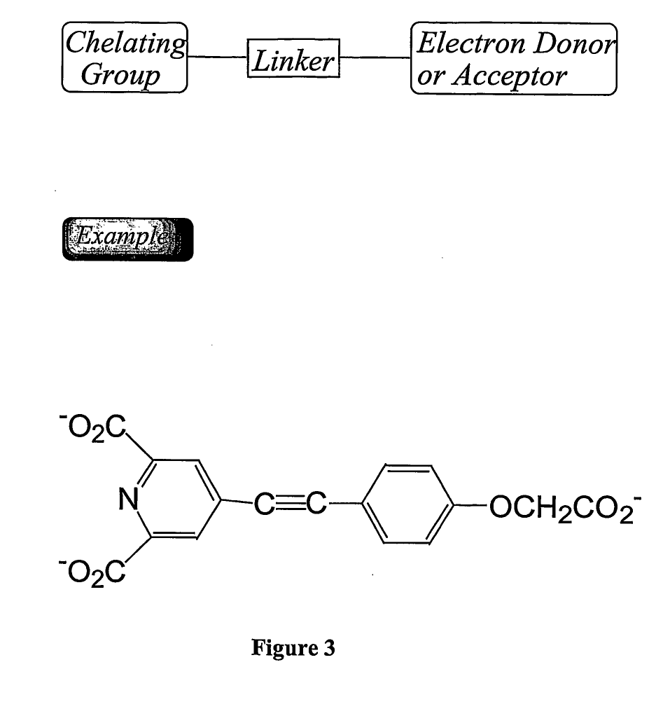

The effect of adding a charge transfer (CT) feature to the local ligand transition is shown in Table 1, which illustrates absorption and luminescence data for the europium compounds shown in FIG. 1. Listed are wavelengths for absorption by the free ligand in a common solvent as well as the peak wavelength and peak extinction coefficient for the corresponding Eu chelates. Additional data are provided that show the expected luminescence features for these complexes (see '891). These include the luminescence lifetimes for chelates in buffered water solution. The desired shifts that are due to the introduction of CT character to the ligand transition can be brought about by the incorporation of a large variety of electron donor or acceptor groups (FIG. 3) with various linkers. The latter linking moieties may consist of, but are not limited to, groups that provide a degree of pi electron conjugation (such as alkene (C═C), alkyne (C═C), aryl, azo (N═N); in the parent structure the linking group may be absent.

Modifying groups that would be classified as electron donors include, but are not limited to, aryl groups further modified with one or more electron donating substituents such as hydroxy (—OH), alkoxy (—OR), oxide (—O⁻), amino (—NH₂), alkylamino (—NHR), dialkylamino (—NR₂), thioether (—SR), carboxylate (—CO₂—), and sulfonate (—SO₃⁻). A parameter of merit is their electrochemical half-wave potentials for oxidation that should be less positive than E1/2=1.3 V vs SCE. Modifying groups that would be classified as electron acceptors include, but are not limited to, aryl groups further modified by nitro, quinone, carboxyl, ketone, aldehyde, halogen, sulfonyl groups, or carboxylic acid derivatives. A parameter of merit is their electrochemical half-wave potentials for reduction that should be less negative than E1/2=−1.5 V vs SCE.

Of special utility are those substitution patterns for ligands that shift wavelengths for absorption by the appropriate metal chelate to the red, particularly into the region of 350-400 nm, where the sensitization of metal transitions by ligands is possible (note the shift to longer wavelength of the peak absorption for compounds 2, 3 and 4 vs 1 in Table 1). (Also compare luminescence data for compound 6 vs. compound 5.) This wavelength region is appropriate for use in conjunction with a number of different light sources (e.g., Hg lamps) but in particular these wavelengths match light sources that include ultraviolet light emitting diodes (LED's). The latter are increasingly available and provide narrow band excitation at low cost and high efficiency. Yet another feature is that chelates taken together, or a single chelate that is comprised of a combination of different ligands (for example, three ligands coordinated to a lanthanide ion, Ln(XYZ)) will harvest light (broad band excitation) more effectively (e.g., ligands for 1 and 4 taken together).

To facilitate understanding of the invention, a number of terms are defined.

The term “luminescence” refers to emitted radiation that results from deexcitation of a molecule or ion from an excited electronic state to its ground electronic state. The emitted radiation is referred to as fluorescence if the excited and ground electronic states are of the same spin multiplicity (de-excitation does not require a change in spin angular momentum); the emitted radiation is known as phosphoresence if de-excitation is “spin forbidden” and requires a change in spin angular momentum. Luminescence is a process that normally requires the absorption of light at one wavelength, resulting in excited species which are fluorescent or phosphorescent at a different (usually longer) wavelength; R. S Becker, “Theory and Interpretation of fluorescence and Phosphorescence,” Wiley-Interscience, pages 76-97, New York, 1969.

The term “luminescent compound” for the purposes of the present invention, refers to a substance that is capable of emitting electromagnetic radiation as the result of photoexcitation.

For the purposes of this invention, we define luminescence as “short-lived” if the decay time associated with that emission is shorter than 1.0 microsecond and “long-lived” if the decay time is longer than 1.0 microsecond. It is understood, although not strictly required, that these ranges of time scale can be defined, respectively, as fluorescence and phosphorescence. In general, the more inclusive term that defines emitted radiation, luminescence, will be used in describing essential elements of the current invention.

The term “luminescence decay time” refers to the profile of luminescence intensity as a function of time for a composition that gives rise to fluorescence or phosphorescence, and any interchangeably be referred to herein by the term “fingerprint” (or “time resolution of emission”), to signify the particular profile of any specific composition. The luminescence of any composition will grow and decay in a particular period of time with respect to an initiating light pulse; the decay profile will be a particularly sensitive characteristic of the specific composition or combination of composition and chemical environment in which that composition is bound; J. N. Demas, “Excited State Lifetime Measurements,” Academic Press, pages 12-42, New York, 1983. The luminescence decay can be plotted graphically as an intensity versus time plot, and subjected to mathematical analysis that allows a quantitative description of the shape and descent of the decay curve. Most commonly, a luminescence decay will follow an exponential function; however, the decay pattern may be more complex, reflecting the possible array of compositions that display different properties of the composition, or different physical environments. More complex decay functions that can be shown to fit an observed luminescence decay pattern include multiple exponentials (double, triple, etc.), a “stretched exponential”, a Gaussian distribution of exponentials, or other complex functions, J. N. Demas, supra.

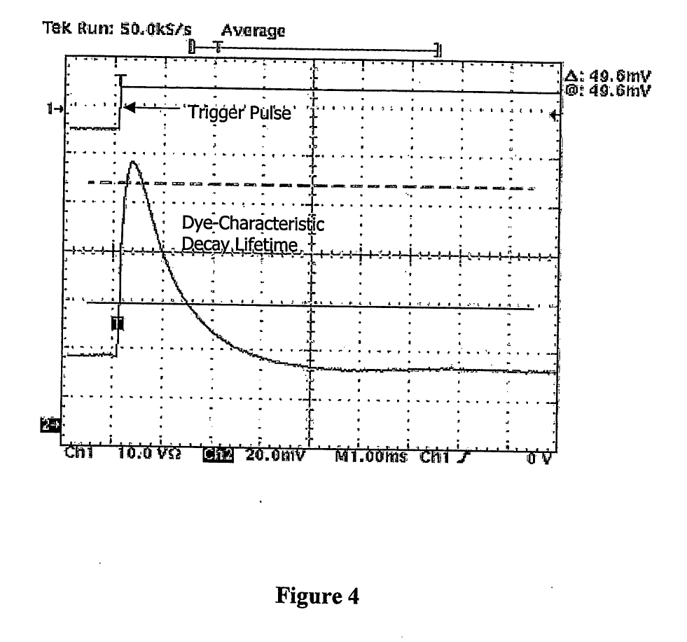

The decay time (τ or 1/e for an exponential function), as it is defined, is a characteristic of the luminescence compositions of the present invention. In one embodiment, luminescence from a marked substrate will follow a single exponential decay. In the accompanying FIG. 4, the luminescence of chelate 4 (described in Table 1) is shown, along with the identification of the material that is marked and the experimental conditions used for observation. The parameters associated with this embodiment are (a) the intensity profile (FIG. 4), (b) the log plot of intensity vs. time that is a linear function for a single exponential decay, and (c) a luminescence lifetime (having the symbol, τ) that results from the slope of the log plot or from other curve fitting procedures. Typical decay constants (τ) for lanthanide chelates, and a variety of other metal complexes in general, commonly fall in the time domain of 1 microsecond to 1 second, depending upon environmental conditions.

In other embodiments, luminescence followings a decay pattern that is described best by two exponentials. The double exponential behavior can be illustrated with a log plot; two decay times, τ₁ and τ₂, result from analysis of two linear portions of this type of graph; J. N. Demas, supra. In other embodiments, the decay time of a luminescent species can be expressed as lifetimes associated with single or multiple exponentials (τ₁, τ₂, τ₃, etc.) or with parameters associated with stretched exponential fits or Gaussian distributions of lifetimes, or simply as a weighted or unweighted average of the various distributed quantities.

The term “chelate” as defined herein, is a compound comprising one (or more) metal centers and a ligand that in turn provides coordination sites for metal bonding (e.g. the europium/ligand structures of FIG. 1).

The term “lanthanide chelate” as defined herein, is a compound comprising a metal from the lanthanide series of chemical elements that is coordinated to one or more ligands. “Ligand” is defined as an organic or inorganic molecule or ion that is capable of chemical coordination to a metal. Examples of ligands include, but are not limited to, 1,3-diketones, heterocyclic compounds, including the bi- and terpyridines, polycyclic azoaromatic compounds, dipicolinic acid, coumarins, phenols, and salicylic acids. These ligands are normally capable of taking up two or more coordination sites on the metal. The present invention does not limit the metal to the lanthanide series of chemical elements. A variety of chelates or metal complexes are contemplated, and the compositions of the present invention may comprise any type of metallic element (including for example, ruthenium, copper, yttrium, or iridium).

The term “luminescence lifetime modifier” refers to a chemical agent that is capable of altering the emission lifetime (i.e. the decay time, as measured using procedures in the present specification) of a sample containing a luminescent compound. Examples of luminescence lifetime modifiers include, but are not limited to, imidazole, analogs of imidazole, derivatives of imidazole, alkene polymers, polyesters, biopolymers, carboxylic acids, ketones, amides, phosphine or pyridine oxides, or polymers that provide coordination sites for metals including poly (vinyl acetate) and poly(vinylpyrrolidinone). The term “luminescence enhancer” refers to a luminescence lifetime modifier that enhances the luminescence of a luminescent compound when tested under the conditions described herein.

The term “substrate” as used herein, refers to a material having a rigid or semi-rigid surface. Such materials will preferably take the form of either organic or inorganic materials, such as paper (e.g. colored, plain, currency, bank notes, stocks, bonds), plastic, leather, cloth, thread, metal, and glass, or other convenient forms may be used. Other substrates may include plastic label stock, plastic card stock, metal or plastic foils, holographic foils and materials and adhesive layers associated with labels. In some embodiments, at least one surface of the substrate will be substantially flat. Other types of materials that can be usefully doped or tagged include sprays, adhesives, or films and coatings. A substrate may be marked, labeled, tagged or otherwise designated or sorted as the result of application of a luminescent composition of the present invention.

The term “metal” as used herein, refers to a metal center, a metal ion, or a metallic element, without regard to any specific oxidation state.

The tags described herein are contemplated as being used on documents, products or other substrates for the purpose of authenticating said documents, products or other substrates, examples of which include, but are not limited to, paper (e.g., plain, colored, currency, bank notes, stocks, bonds), cloth, plastic, leather, thread, metal, glass or combinations thereof.

Examples of goods that would be most appropriately marked using the formulation of organic solvent, lanthanide chelate, and lifetime modifying agent include, but are not limited to, credit or identification cards, gift cards, wrapping, film, label or card stock, printing inks, sprays, adhesives, packaging for pharmaceuticals or software, labels, foils, other forms of plastic wrap, and hard plastic compositions found in autos or aircraft and in games and toys. Holograms, including those that may be employed otherwise as security features, can have extra security marks placed on them as well using this method.

The tag is applied to a substrate using any one or a combination of methods of printing, for example ink jet, continuous ink jet, thermal transfer, pad, offset, gravure, flexographic, or screen printing.

A method is described whereby products or documents can be identified based on the recording of a luminescent image. The image consists of a discrete luminescence spectrum and a well defined luminescence decay time. Using a pulsed source for photoexcitation, luminescence intensities are recorded as a function of time following initiating pulses of light. Wavelength and time resolution of luminescence signals produces a unique signature that can be identified with a particular product or document. This coding of luminescence information can be detected using a scanning device that can store or transmit data for recovery and use in the verification of product or document identity. The technology is enabled through the use of, for example, metal chelates that show discrete luminescence signals whose decay times are an adjustable variable that depends on the selected metal, the chelating ligand, and modifying agents that provide further control over luminescence lifetime. Two or more chelates may be used in combination to provide a decay time profile that can reflect a weighted average of the two respective decay constants (τ₁ and τ₂) or appear in two time domains that are discriminated.

Luminescent compositions are identified that provide a means of marking a substrate, using luminescence decay time as an adjustable and readable parameter. In preferred compositions that include rare earth chelates and chemical agents that act as lifetime modifiers, multivariable codes are produced for the purpose of tagging products or documents. The methods described will be well suited for control of product inventory, and in measures that counter product diversion and counterfeiting.

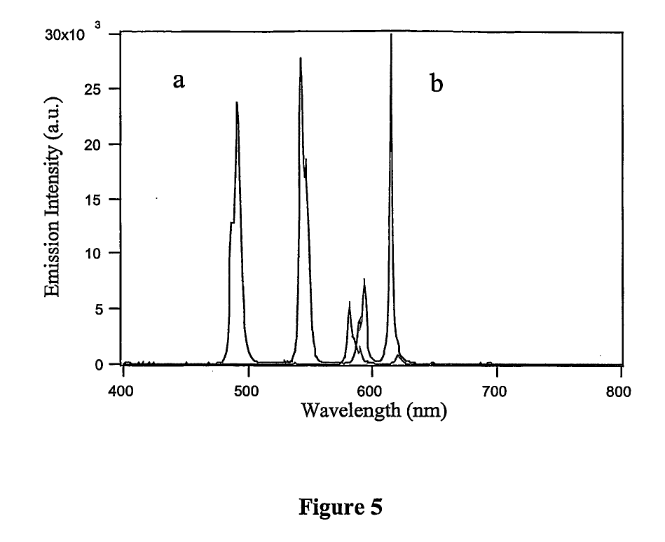

The photoluminescent signal that constitutes a covert label under the preferred embodiments has a combination of innovative features. We summarize the important features of the spectroscopic data as follows. As shown in FIG. 5 for europium and terbium chelates, luminescence occurs in relatively narrow lines that are better resolved than the fluorescence that is commonly observed for conventional dyes. Chelates show low absorptivity in the visible region, so that marks are not visible to the naked eye. Luminescence can be observed by combining two dyes and using selective excitation in the UV as shown in FIG. 5 for a combination of Eu and Tb chelates. The present description is not meant to limit the use of the lanthanides, but encompasses other elements in the lanthanide series, including, for example, gadolinium, samarium, ytterbium, or neodymium. This assortment of chelates, therefore, provides luminescent materials with windows of utility that span the visible spectrum (400-700 nm) and extend the method of marking to near-infrared wavelengths (700-1100 nm).

The elements that are new in this methodology involve the demonstration that lifetimes of chelates for a variety of substrates (e.g., paper, cloth, plastic) can be marked with a code that will be read as an image, a wavelength (color), and a decay time. Thus, the tag has characteristics that can be detected and can include such variables as image (e.g., the shape of the security mark), color or wavelength, or decay time of the luminescent components, or any combination of these variables. Important to this new method is the development of new chelates that show superior absorption and energy transfer features, particularly for sensitizing the luminescence of europium chelates. In addition, following an assessment of the photostability of a number of classes of chelates, it was determined (in '891) that previously reported structures (particularly chelates having the 1,3-diketone type of ligand) do not show long term stability to light. New chelates having higher stability toward photochemical decomposition (compounds shown in FIG. 1) have been shown to produce emission signals with reproducible characteristic lifetimes for luminescence decay in the millisecond time domain. Moreover, classes of lifetime modifiers (e.g., derivatives of imidazole that serve as ancillary coordinating ligands, or coordinating polymers such as polyvinyl acetate), have been identified which can be used in conjunction with a variety of chelates in order to produce a matrix of variables that include emission wavelength and decay time. It is further demonstrated that a combination of one or more dyes having variable lifetimes according to individual compositions of the marking ink can be scanned for recording wavelength and decay time with high fidelity. Also described is a simple inexpensive detector that can be used for the collection, digitization, and communication of luminescence data.

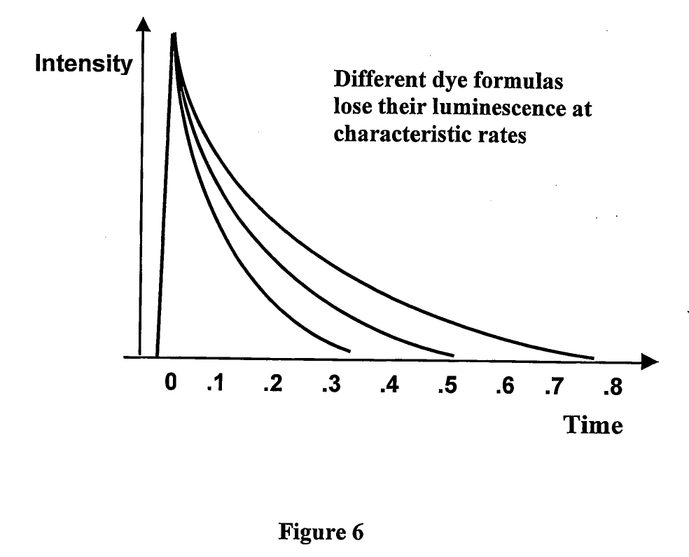

Security features will display not only a physical image and a color (luminescence wavelength) upon interrogation. A critical additional level of security is associated with “lifetime imaging”—i.e., a covert signature will also include a well defined luminescence decay time, a distinct but adjustable property of each chelate and the medium in which it resides. Lifetime imaging is carried out using pulsed light excitation for sampling. The results of recording lifetimes for various samples are shown in FIGS. 4 and 6. Luminescence lifetime data are compiled in Table 2 that show (see '891) the versatility of the method in terms of application of different dye formulas having different lifetime modifiers to paper.

The success of lifetime imaging as a security feature depends critically on two factors: (1) the reproducibility of lifetimes for a given sample (the combination of chelate, the medium with which it is applied, and the substrate); and (2) the ability to alter lifetimes in a systematic manner by “tuning” the application medium. The lifetime data shown in Table 2 confirm that both of these criteria are met. The variance in lifetimes is based on the computed average deviation of data based on 3-4 independent measurements of single exponential decays. Thus, lifetimes recorded for a single composition of chelate/medium and substrate are shown to be reproducible to within ±5%.

In order that lifetimes be adjustable and therefore part of a matrix of information that is retained in a luminescent security feature, further alteration in the photophysical properties of chelates is required. We have adopted a strategy in which additives to the application media for a set of chelates are introduced. We have identified two types of additives or modifiers that are most suitable for altering the lifetime of chelates. The first is the molecule, imidazole, and by extension structures having the imidazole ring, including histidine and its derivatives, N-aryl or N-alkyl imidazoles, and annulated structures in which additional aromatic rings are fused (e.g., benzimidazole and the like). The changes that we have observed for emission intensities and lifetimes upon addition of imidazole to solutions of chelates before application are presumed to be related to the change in number of water molecules remaining at coordination sites that are responsible for luminescence quenching. The effectiveness of imidazole and its simple derivatives as coordinating ligands can be rationalized on the basis of a donicity parameter (basically the ability of the heterocylic ring nitrogen to act as an electron pair donor). For example, stable coordination complexes in the solid state of the lanthanides, europium, yttrium, and cerium, and N-methylimidazole have been reported (W. J. Evans, et al., Chem. Commun., 2367 (1998); W. J. Evans, J. Coord. Chem., 34, 229 (1995)).

The new findings that are enabling have to do with the systematic modification of lifetimes that can be brought about by addition of imidazole to chelate reagents (Table 2). The data in sum demonstrate that lifetimes can be modified typically 25-50% on the addition of an imidazole modifier.

Another interesting feature of the luminescence data is the subtle change in peak emission intensity that is observed for the principal lanthanide emission bands on addition of a coordinating group (“modifier”). For example, addition of imidazole brings about a change in the intensity ratio. This determination is consistent with the finding that the electric dipole character for the ⁵D₀-⁷F₂ band (612 nm) is more sensitive to the ligand field and can reflect the number of coordinating ligands of a particular type (G. Blasse, Adv. Inorg. Chem., 35, 319 (1990)).

A second class of modifier is most efficacious in situations in which a lanthanide chelate is applied via an organic solvent. This type of composition of security ink is most appropriate for marking materials comprised of conventional plastic (e.g., vinyl polymer or polyester). The preferred modifier for this type of substrate is poly(vinyl acetate) (PVA), a well known commercial alkene polymer having a molecular weight in the range of 10,000-500,000 Da (K. J. Saunders, “Organic Polymer Chemistry”). We have demonstrated that for europium chelates that employ ligands of the 1,3-diketone class, the luminescence intensity (in the absence of an additive) is reduced and emission lifetimes are shortened for marking inks that utilize common solvents, including dichloromethane, chloroform, acetone, or ethyl acetate. Increases of 30-40 fold in luminescence intensity and lifetime are observed for ink compositions that include moderate concentrations of PVA (e.g., millimolar range) (see '891).

The addition of one lifetime modifier to a set of chelates, in effect, multiplies the number of unique luminescent reagents by two or more, depending on the effect of different concentrations of the added modifying reagent. The matrix that finally develops is quite robust, employing a wide range of adjustable parameters. The choice of lanthanide metal determines the wavelength regime in the visible and near-IR for interrogation. The choice of chelating ligand controls the base lifetime for a particular metal and substrate, with reasonable variations that can range by as much as a factor of 100 (e.g., 0.1-10.0 msec). Further adjustment in the luminescent signal is accomplished by addition of a lifetime modifier (e.g., imidazole or PVA). Still further differentiation in the security feature can be made on the basis of the ratio of vibronic intensities for a particular chelate; i.e, a ratio of emission peak heights can be measured using a steady irradiation source or pulsed excitation (e.g., for europium chelates, %=ca. 592 and 612 nm). The combination of multi-color, multi-decay-time interrogation offers unprecedented versatility in terms of systematic alteration of covert identifiers.

Yet another class of luminescent compounds that provide long lived emission, in a suitable range for recording by simple detectors, are metal-based pigments such as those having metal oxide or metal sulfide structures. Examples of these pigments that absorb ultraviolet light and emit light in the visible range include composites of zinc sulfide and copper or manganese (e.g., ZnS:Cu) (or yttrium-europium structures (e.g., Y₂O₂S:Eu). These compounds give rise to luminescence that displays decay times of 0.3 to 25 ms when they are applied to paper or label stock with a suitable dispersant (e.g., poly(vinyl acetate), PVA.

In addition to the dyes disclosed in '891, it has been found that any luminescent dyes, or pigments, can be used herein. When one considers that there are virtuallyy unlimited number of possible sizes and shapes of the “printed” version of each dye (see '891), including each dye being printed in the shape of a letter or number, one realizes the number of permutations. In addition, the concentration of dye (i.e., amount of dye per surface area) can be varied, in order to vary the amplitude of the signal. If more than one dye is used, the relationship (e.g., ratio) between concentration of the dyes is another variable. Having the ability to utilize such a large number of combinations of dyes, plus the ability to frequently change the combination and communicate identification to those who need to authenticate products/documents provides a system that is extremely difficult to counterfeit.

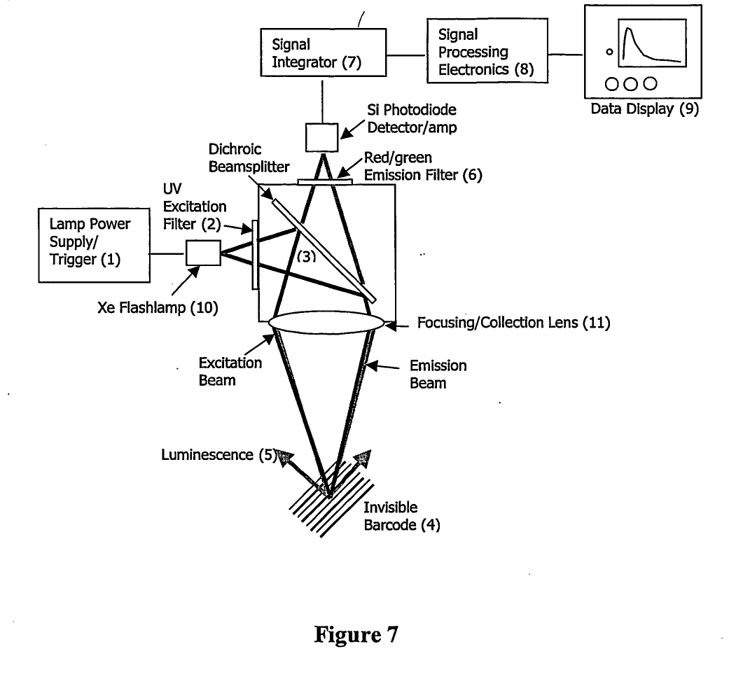

Consider the attached Diagram as depicted in FIG. 7. The signaling and data paths commence with the Power Supply 1 that provides the electrical excitation for the optical source, and may also provide power to other electrically-powered elements of the optical component, generally an optical scanning unit, which consists at least in part of a Scanner system such as the Scanning element, the Detection element, the Electronics, etc. The Power Supply can consist of a battery, an AC/DC converter, or other similar element(s) or combination. The Light Source 10 provides the optical excitation for the Mark. It may consist of a pulsed Xe strobe or flashlamp, a broadband source such as a halogen lamp or incandescent, a chopped broadband source, a discrete source such as a laser, LED or super-luminescent LED, a time-modulated broadband or discrete source, etc. The Source can consist of one or more of these optical sources; for example, it might incorporate several narrow-band LEDs to excite a variety of luminescent compounds. The Source must provide spectral excitation at the wavelength appropriate for the emitting species. The Source may also be operated CW (continuous wave) to illuminate the Mark for its detection and spatial localization. And finally, the Source may be a combination of CW and modulated sources, or a source that can be operated both CW and in a modulated fashion. The Source will provide optical output that may include, but is not limited to, UV and visible wavelengths.

The UV Excitation Filter 2 shapes the optical spectrum of the Source. It can consist of a grating, a dielectric filter or stack, a short-pass filter, a band-pass filter, a line filter, a glass filter, or any other optical spectrum-shaping element. The Excitation Filter may incorporate several of these filters, for example in a filter wheel. The Excitation Filter will further resolve the optical output and tune in the absorption or excitation wavelengths of the Mark. For certain narrow-band sources such as lasers, the Excitation Filter may be optional. The Excitation Filter will shape the optical output over a spectral range that may include, but is not limited to, UV and visible wavelengths.

The Delivery Path 3 consists of a fiber or fiber bundle, a lightpipe, any other type of optical waveguide, air or some other medium, and/or free space optics such as lenses. The Delivery Path spatially (and spectrally) formats and efficiently transmits the excitation light to optimally excite the Mark.

The Mark 4 may consist, for example, of luminescent dye(s) and/or inks formulated with luminescent dyes, capable of producing an emitted optical spectrum under optical excitation. The Mark may be a thin film, barcode, 1-D or multidimensional barcode, marking thread(s), or labels. The Mark may be printed by a variety of methods, including, but not limited to, ink jet, thermal transfer, dye sublimation, or screen printing. The Mark may be incorporated in a label, card, foil or part, (e.g., dye incorporated as a dopant in plastic label or card stock or adhesive, or foil), in fabric or in thread. The Mark may be applied with a laminant layer or incorporated into an adhesive layer. The Mark may be applied to packaging: for example, as pharmaceutical packaging such as boxes, plastic wrap, bottles, and/or bottle caps.

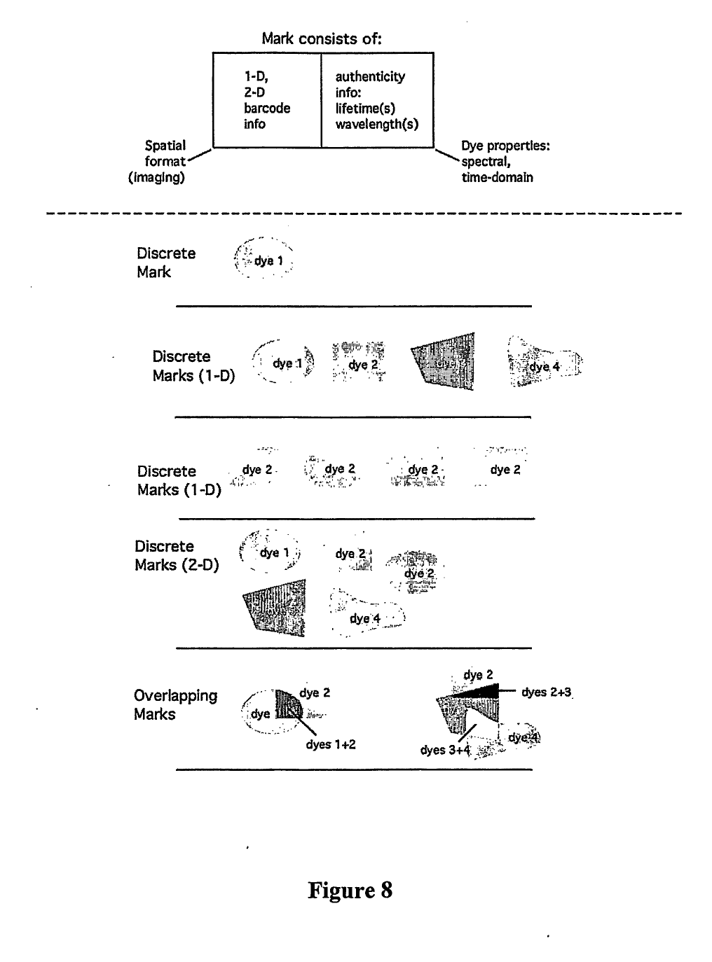

The Mark may incorporate one or more spatially-distinct areas that incorporate luminescent dyes, said dyes and their deposition being described in '891. The Mark may alternatively incorporate two or more spatially overlapping areas that incorporate fluorescent dyes, said dyes described in '891. The Mark may incorporate two or more spatially overlapping areas that are coextensive that incorporate luminescent dyes, said dyes described in '891. The Mark may, alternatively, incorporate some combination of spatial areas that may be distinct or overlapping that incorporate luminescent dyes, said dyes described in '891. Some of these various embodiments of the Mark are illustrated in FIG. 8. Once photoexcited, the luminescent compounds incorporated in the Mark will emit at specific wavelengths. This luminescence may be CW for detecting and locating the Mark, and will have an emission decay time signature(s) corresponding to the dye(s) incorporated therein once the Source is turned off, or is modulated (i.e., pulsed). The Mark may include 1-D and/or 2-D barcode information in addition to authentication “signature” information.

The emission from the Mark 5 (FIG. 7) travels the Collection Path. This path consists of a fiber or fiber bundle, a light pipe, any other type of optical wave guide, air or some other medium, and/or free space optics such as lenses 11. The Collection Path efficiently gathers and spatially (and spectrally) formats the excitation spectrum; for example, it may route, collimate, and/or focus light emitted by the mark under excitation. The Collection Path may be coincident, or have significant overlap, with the Delivery Path through use of a bifurcated fiber, or dichroic beam splitter or other filter(s). This latter configuration is not shown in the block diagram. The luminescence may consist of wavelengths in some portion(s) of the UV, visible, and infrared regions of the spectrum.

The Emission Filter 6 shapes the optical emission spectrum of the excited Mark. It can consist of a grating, a dielectric filter or stack, a short-pass filter, a band-pass filter, a line filter to filter out ambient light, a glass filter, or any other optical spectrum-shaping element. The Emission Filter may incorporate several of these filters, for example in a filter wheel. The Emission Filter must pass spectral power in the emission wavelength bands of the Mark luminescence. The Emission Filter may pass wavelengths in some subset(s) of the UV, visible, and infrared portions of the spectrum.

The light that passes through the Emission Filter may be further formatted spatially by a Scanning element. This Scanning element may consist of a holographic, galvanic, electro/optic, MEMS, or other transmission or reflective scanning element or elements, and may be scanned in 1-D or 2-D. Similarly, the light from the Source may be optionally scanned in this fashion.

The Detection element (s) 7 convert the emissive output(s) of the Mark into electrical signal(s). The Detection element may consist of one or more discrete detectors such as PMTs; silicon, GaAs, AlGaN, InGaAs, or similar optical semiconductor detectors; bolometers; a multiplicity of these detectors in a linear or 2-D array; or a multiplicity of semiconductor detectors such as are found in a linear or 2-D CCD or CMOS arrays. The choice of detector(s) is determined by the amplitude, speed, signal-to-noise ratio, and spectral bandwidth of the Mark's emission(s). These may have integral amplification. The Detection means may be synchronous or asynchronous with the Source's modulation and/or triggering.

The Electronics 8 may consist of one or more preamplifiers, lock-in amplifier(s), wide-band noise rejection filter(s), narrow-band electrical filter(s), other analog signal conditioning, timing and gating sources, triggering outputs and inputs, and may also include one or more channels of A/D conversion and/or other digital signal conditioning.

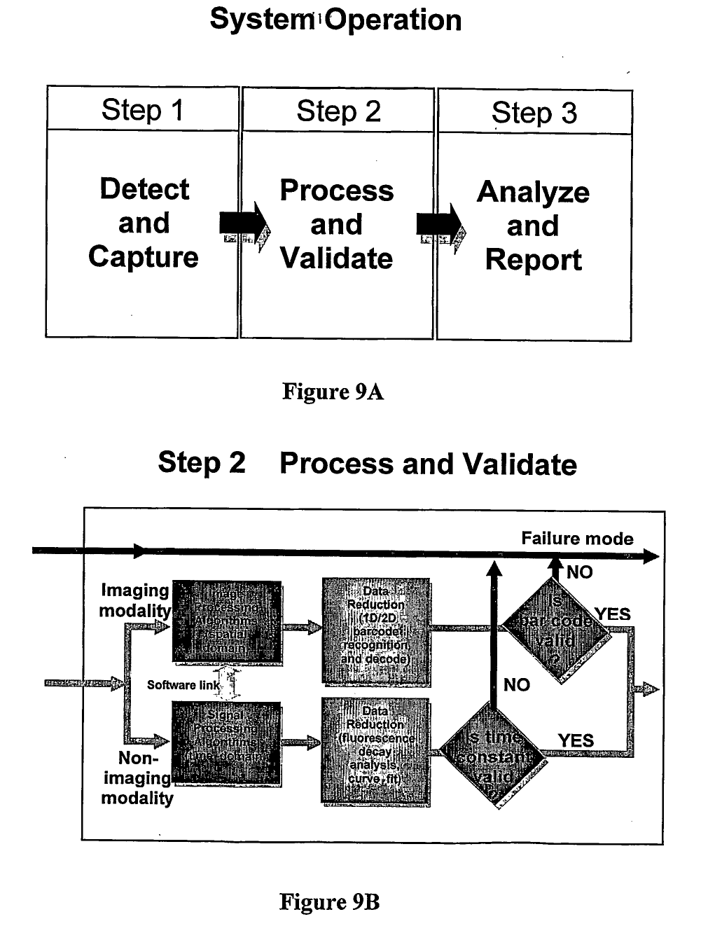

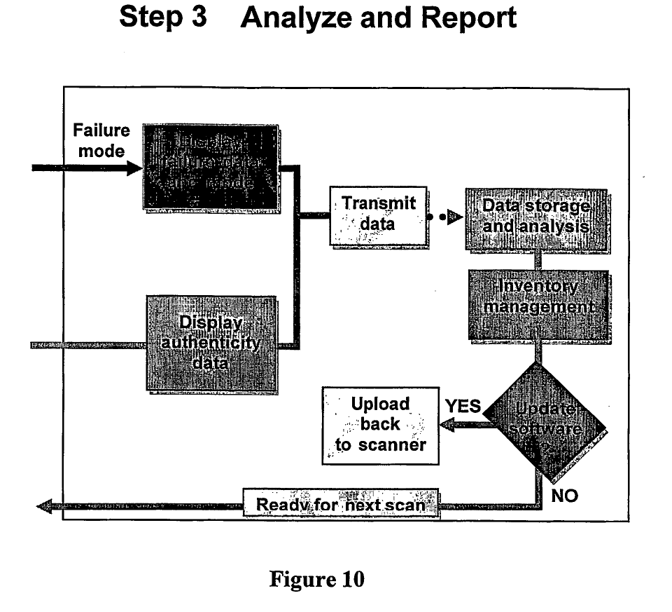

The Processor will typically consist of a CPU, which can be a microprocessor, microcontroller, RISC processor, ASIC, PGA, or other digital processing means. In certain embodiments the processing may be done via analog circuitry, or even an analog/digital hybrid. The Processing functions can reside within the Scanner itself; within a separate “box” that is connected to the Scanner via a cable, RF link, or infrared (IR) link; or even at a remote location where the Scanner is “connected” to the Processing via a data network such as an RF LAN, Ethernet, the Internet, etc. The scanning function may also be incorporated as a module that is connected directly to a computer (including hand held devices) that is further enabled to communicate with an area network or the Internet. In digital embodiments the Processing block will run software that decodes the temporal aspects of the optical signatures emitted by the Mark. For example, the processing may involve a time-sampled waveform of the emission amplitude, and compute a decay time (or times) to assess the luminescence emission lifetime(s). This computation may be affected, for example, by a curve fit to a luminescence emission decay curve. These decay lifetimes may be, but are not limited to, nanosecond, microsecond, and millisecond time scales. The Processing may then also compare this lifetime(s) to a set of admissible lifetime(s), and determine whether these signatures match those of an “authentic” Mark. This “database” of admissible time stamps, spatial patterns of the Mark, and combinations thereof may be “hard wired” into the Scanner, may be programmed into the Scanner, may be uploaded to the Scanner via some external Data Link, or may be stored at some remote location (in this last embodiment, a “compressed” version of the raw data from the fluorescence emission, such as a table of fluorescence decay lifetime(s), would be transmitted over the Data Link to a Remote Host). A block diagram illustrating the processing scheme is found in FIGS. 9 and 10.

In another embodiment of the system, the information modulated by the Mark and measured by the Scanner is the Mark's selective influence on the known input polarization state of the Excitation Spectrum. For example, the plane polarization state of the excitation light may be rotated with respect to the polarization of the emission from the Mark. The amount of rotation is affected by the alignment of the Mark dye molecules and the length of the emission decay time. This provides another unique “signature” for the Mark that also may be used for authentication: the time-resolved polarization state of the emission spectrum.

Upon the completion of this comparison, the Scanner's Display (9 in FIG. 7) would provide the user with an indication, for example, of whether or not a Mark was detected, and whether this Mark was “authentic”. The Display can also provide the user with an indication of the system's status, power on/off, etc. The Display can consist of an LCD readout, CRT, one or more LEDs of one or more color, incandescent lights of one or more color, or some combination of these elements. The Display may be augmented by an audible output that can provide another means of alerting the user to the aforementioned indications.

The Scanner can optionally incorporate a Data Storage element. This can consist of an EPROM, ROM, RAM, or other memory element(s); a smart card or other static data storage card; a disk drive, CD-ROM, DVD, etc.; or any combination of these elements. This can “house” system software, analysis and processing software, data from a scan or series of scans stored in data file(s), product authentication “truth data” for comparison with scanned data, etc.

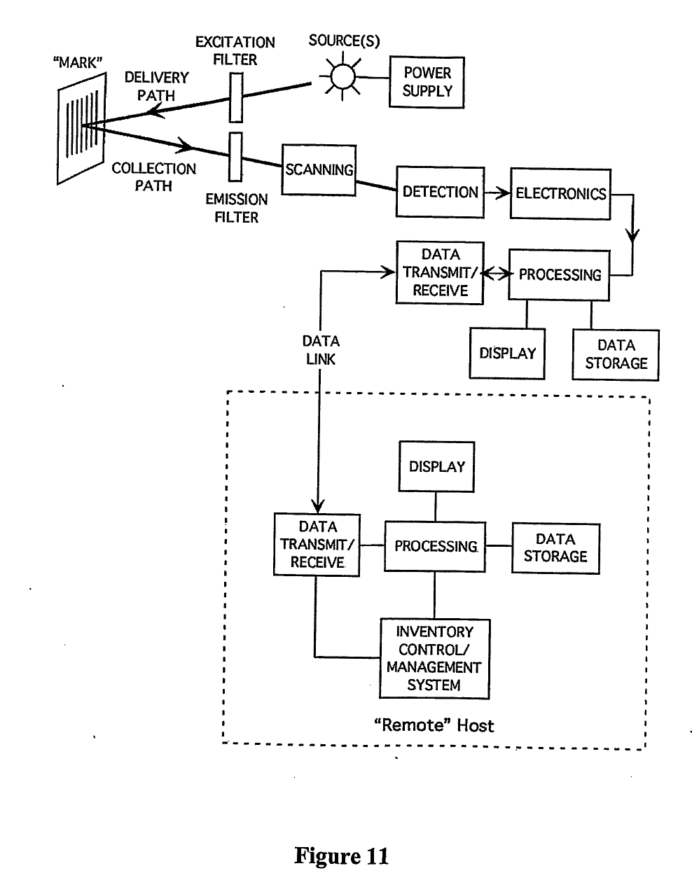

The Scanner can optionally incorporate a Data Transmit/Receive element to mediate the transfer of data between the Scanner and a Remote Host (FIG. 11). These data may include inventory control/management information, product authentication “truth data” for upload to the Scanner, raw and/or reduced data from the Scanner, data files, and/or other data relevant to the operation of the system. The Data Transmit/Receive element can be a modem, RF LAN transceiver, UART or other serial controller, IEEE-488 bus controller, Ethernet card, cell or satellite phone, or other network interface.

An optional Remote Host will consist of Data Transmit/Receive, Processing, Data Storage, and Display elements that are analogous to those found in the Scanner. For example, the Remote Host may be a server employed on a network that can interface to one or more scanning systems, and can optionally include connections to or even include an Inventory Control/Management System. This system would permit authorized personnel to maintain a database of authentication codes that is continually updated as new dyes are produced, and then incorporated into unique marks, with appropriate links to relevant product/batch/lot data.

The Scanner itself will optionally include the Power Supply (or a cable connecting it to one), the Source(s), Excitation Filter, the Collection Path element, the Emission Filter, the Scanning element (as necessary), the Detection element, and the Electronics (FIG. 11). In such a configuration, the Scanner can even be hand-held. One likely embodiment would be an imaging Scanner which both detects, landmarks, image processes, and authenticates the Mark. Another embodiment would further include the balance of the elements outside of the Remote Host block within a hand-held unit. These two Scanner embodiments may be fixed in space, and mounted on or near a conveyor system to automatically scan products as they pass the fixed Scanner. In this embodiment the time signature may be detectable using two or more adjacent Detection elements or Scanners, with the spatial separation between these elements effectively “scanning” the Mark where, rather than the excitation spectrum being spatially scanned over the Mark, the Mark moves with respect to a fixed spatially-formatted excitation “beam”.

The information technology component used herein (typically a computer) must be capable of analyzing all of the potential systems being evaluated by the system. If the system is being utilized by an organization that must authenticate many products or documents, both the scanner and information system must be capable of detecting many dyes and must be capable of storing information on the authentication characteristics for many products. As indicated, the authentication system must be capable of changing the dyes at any time in order to reduce the likelihood that counterfeiters can “break the code” and create a substitute label system. Therefore, the information technology must be capable of receiving periodic input, either via computer disk, eMail transmission, internet connection, manual input, or other method in order to keep current the information about the product or products (or document(s)) being authenticated.

In addition to the system described above, applicant has identified the method for product or document authentication which can use any dye or combination of dyes, in conjunction with the detector and information system described above.

The advantages of the integrated system for product authentication are (1) the product(s) can be marked in a covert manner, and these marks can be changed frequently, offering may unique “fingerprints” that can correspond, for example, to product batch or lot numbers; (2) the integrated system can be intelligent, and “know” about the full variety of fingerprints via its IT interface and functionality; (3) the system can be reprogrammed—even remotely—to accommodate new fingerprints, dye time signatures (luminescence lifetimes), dye excitation and emission wavelength bands, etc., through its IT interface; (4) the system can be integrated with an inventory control and management system, to serve both as a conventional mark/scanner system and as a product authentication system; and (5) the system can be portable and compact.

Further variations in the method are possible, since the method can utilize tags which are all in the visible range. Thus, two or more visible tags can be evaluated using the method or system disclosed herein.

Further variations are also contemplated having to do with when the tags are applied. For example, one tag could be applied when the document or product is first prepared, while a second tag could be applied when a second significant activity takes place (for example, adding important information to a document or exposing the product to a special treatment, such as exposure of the product to sterilizing radiation). Alternatively, the information to be coded can be accumulated and all applied at the same time.

Another variation deals with the relationship between the spectral characteristics of the dyes. For example, the ratio of amplitude of the dyes at their maximum emission wavelength can be the characteristic used to determine authentication. Yet another variation can be employed in a forensic application, as follows. Two or more dyes may be used in combination such that detection of luminescence at two wavelengths is possible. A sample can be recorded with regard to a ratio of peak intensities or decay times before placement in the field. On return, the item can be interrogated again, following a pre-treatment with heat or light (electromagnetic radiation) or washing. With proper dye selection, there will be a selective degradation of dye by the pre-treatment, leaving part or all of a remaining dye substance that will reveal a unique “before and after” luminescence, or signature. Such variations in spectral characteristics can also be evaluated and reported by the information technology system. Examples of treatments that can be used include:
1. heating tagged samples in a drying oven before spectral analysis (approximately 10 minutes to 24 hours at 50-250 C.),
2. irradiating tagged samples before spectral analysis using lamps that include, but are not limited to, xenon, halogen, or mercury, or laser sources that include but are not limited to, solid state, Nd/YAG, dye, or nitrogen lasers,
3. washing tagged samples before spectral analysis with solvent, wherein the solvent can, for example, be selected from the group consisting of acetone, tetrahydrofuran, chlorocarbon, ethyl acetate, toluene, dimethyl sulfoxide, dimethylformamide, water and mixtures thereof.

The following examples are intended to further illustrate, but not limit, the invention.

### EXAMPLE 1

The detection of luminescent radiation, and the recording of steady state emission and excitation spectra, can be carried out using a Photon Technology International, Inc., QuantaMaster luminescence spectrometer, model SE-900M. Emission lifetimes can be measured using a PTI TimeMaster fluorescence lifetime spectrometer, equipped with GL-3300 nitrogen/dye laser as the excitation source (e.g. λexc-337 nm), a DG-535 delay/pulse generator and a strobe detector. Similar instruments, also capable of measuring luminescence decay times in the range from 100 ps to seconds are also available from other vendors (e.g. Edinburgh Analytical Instruments FS900 spectrofluorimeter system). These commercial instruments can be configured to record luminescence spectra and luminescence excitation spectra for the entire range of ultraviolet, visible and infrared wavelengths (e.g. 200-900 nm). Software available from the fluorimeter vendors is capable of decay time analysis including, for example, the computation of luminescence lifetimes, the determination of multiple exponential decay functions, and a statistical analysis of goodness-of-fit to the decay data.

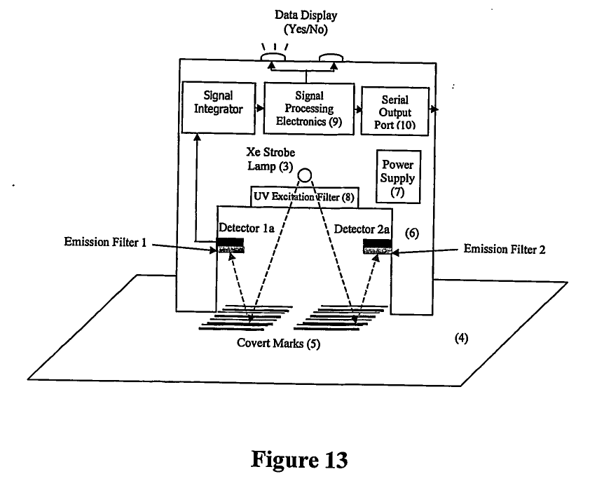

In another embodiment, the comparison of luminescence may be carried out using devices of simple design that allow portability and ease of operation by personnel having minimal training in the field of luminescence spectroscopy. For example, a compact, hand-held apparatus (see FIG. 13) can be fabricated that incorporates a readily available emitting diode light source, and inexpensive diode detector, and simple circuitry that can be understood and implemented by persons skilled in the art of detector electronics. Such a device is illustrated in the description of a UV-scanning apparatus, constructed from available optical and electronic components, that has the capability of discriminating slow-decaying luminescence. These components include a very low-leakage Hamamatsu photodiode (R2506-02), a high impedance (10-12 Ohm) FET operational amplifier (TLO 64), CMOS analog switches (74HC 4066), and a MOSFET low on resistance transistor (IRF 7503) for UV modulation. Utilizing a double differential scheme, the apparatus is relatively insensitive to ambient light and/or temperature changes. Extremely weak signals of luminescence can be sensed by the low-leakage photodiode, if signals are amplified and averaged over multiple periods of the clock generator to improve the signal/noise ratio.

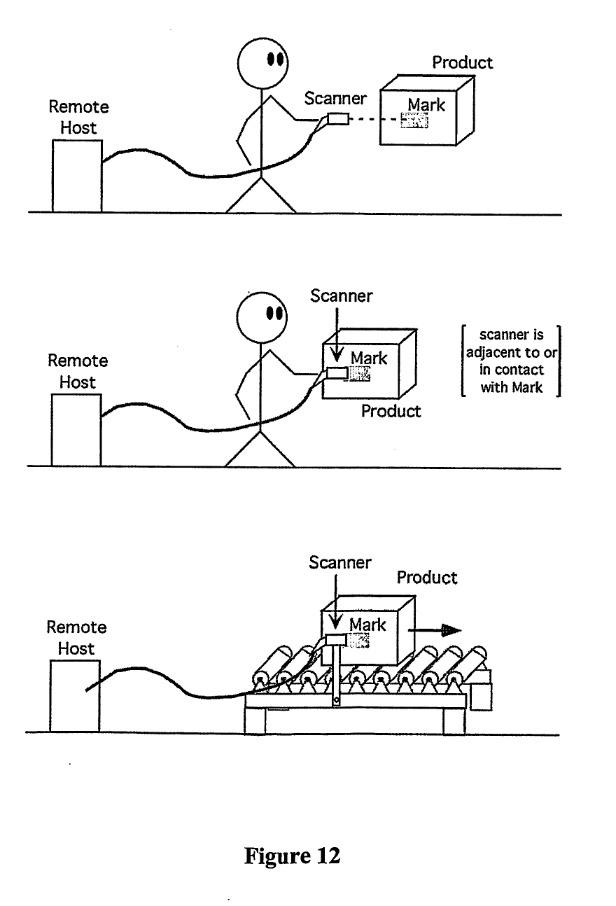

In another embodiment of the present invention, the coding of luminescence information is detected using a scanning device that can store or transmit data for recovery and use in the verification of product or document identity. The storage and transmission of data for recovery may be accomplished via any type wired or wireless communication, and is not limited to any particular distances. Rather, the present invention may be used to achieve the storage and transmission of data for recovery from one physical point to one or several other specified locations. The example is illustrated for a production line detection system as shown in FIG. 12. The three alternatives (top to bottom) are as follows: The top shows the use of an optical scanner as a hand-held device reading a mark at some distance (e.g., greater than one foot). The middle illustration shows a method in which a hand-held device is used requiring contact with the marked product. The bottom illustration shows a fixed-position optical scanner placed at a prescribed distance from a production line carrying marked product.

### EXAMPLE 2

A specific embodiment of the invention has been developed as a prototype in a laboratory testbed environment. This embodiment is shown schematically in FIG. 7. A Xenon flashlamp is employed as a source of fast pulses of ultraviolet light. Using a technique similar to fluorescence microscopy, an excitation filter, dichroic beam splitter, and emission filter are arranged to provide optimum matching of the dye spectral absorption and emission characteristics. In this common-path arrangement, a lens serves as a dual-purpose focusing and collecting optic. The prototype interrogated a proprietary dye that had been ink-jet printed on standard white paper as a covert bar code. This dye/ink formulation had the following properties. An aqueous 0.5 mM solution of a proprietary dye that emits strongly, peaking at 614 nm upon excitation with near UV light was combined with 10% v/v of the humectant, 1,5-pentanediol. This composition was used to fill an HP black/white ink jet cartridge and printed on plain white paper stock and on a variety of different surfaces of commercial paper packaging. Dyes labeled # 5 (green emission, short wavelength UV), and # 6 (red emission, short wavelength UV) were also used. All of these ink jet printed compositions showed bright luminescence under the respective UV illuminations and provided well resolved spectral images of a variety of printed 1D and 2D bar codes.

In this embodiment, the covert barcode emits luminescence with unique spectral, spatial and temporal properties. The emitted light is collected, filtered, and focused onto a standard silicon photodiode detector. This generated signal is then integrated and processed by associated electronics, and sent to a display. In the prototype, the display was provided by a digital oscilloscope which clearly showed the unique characteristic timestamps of the invisible barcodes. The output of the oscilloscope display was digitally captured and appears in FIG. 4. From this decay curve a luminescence decay time was recorded (τ=1.2 ms).

### EXAMPLE 3

Another embodiment of the invention has been prototyped in a handheld “yes/no” digital lifetime detector. This embodiment is shown schematically in FIG. 13. The device is intended to identify arbitrary marks (e.g., barcodes) that are based on the unique luminescent compounds (e.g., europium or terbium chelates) and chemistries described herein. This capability is enabled by specifically designed excitation and emission optics that are “tuned” to the bands of the luminescent compounds, and appropriate signal processing electronics that analyze the observed luminescent lifetime and compare against the known characteristic decays. The handheld prototype contains two separate channels (e.g., one for a europium chelate with peak emission at 615 nm, and another for a terbium chelate with peak emission at ca. 515 nm), which can simultaneously interrogate and analyze multiple, arbitrarily shaped covert marks.

The handheld prototype (FIG. 13) employs a cavity enclosure 6, shielded from room ambient light, containing an internal power supply 7, the excitation optics 8, emission optics 1 and 2, and detectors 1a and 2a. The device is placed near or in contact with a surface 4 (e.g. paper) that may contain arbitrarily shaped covert marks 5. A Xenon flashlamp 3 is employed as a source of fast pulses of ultraviolet light. A UV excitation filter is chosen with a band-pass that contains the excitation (absorption) spectra of both the luminescent compounds. The emission filters are chosen to provide optimum matching of the compound's emission characteristics. The detectors are standard Si photodetectors, whose signals are properly amplified in the signal integrator and sent to the signal processing electronics 9. These electronics integrate the received signal to record a quantity which is proportional to the luminescent lifetime of the mark under observation. After a pre-determined integration time, the algorithms stored in the electronics compare the observed lifetime with the known lifetimes of the compounds, and display the result in the form of and auditory or visual signal specific for each channel (e.g. “yes/no” LED indicators). The result is conveyed to the onboard serial port 10, which can be connected to various standard devices (e.g. a computer) for recording or transmitting to a remote location. The handheld prototype has been used to successfully interrogate dyes of the type described in this application, which have been ink-jet printed on standard white paper as a covert barcode.

### EXAMPLE 4

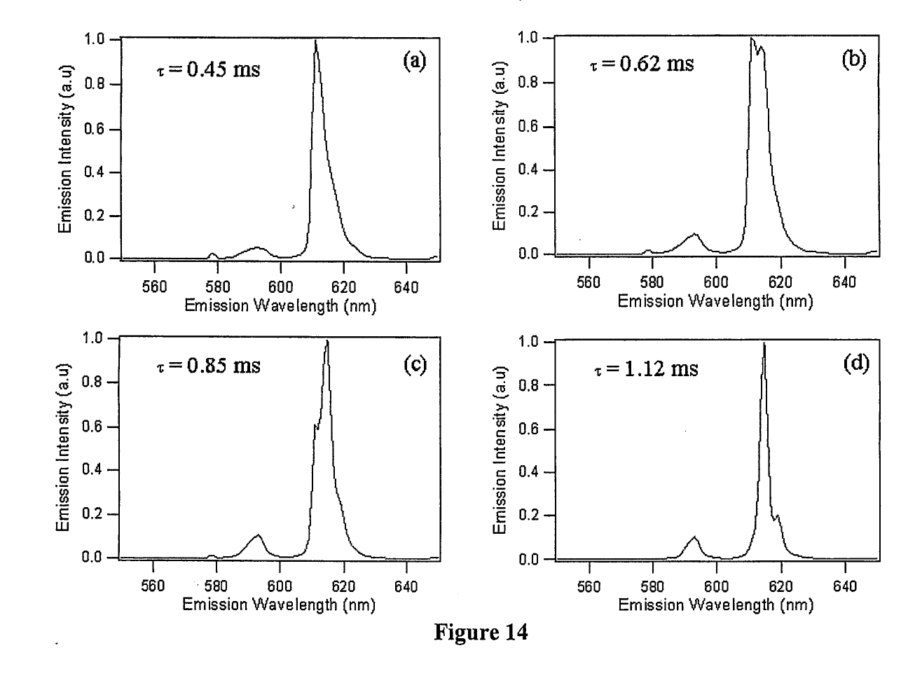

In this example, forensic chelate samples were heat treated. Samples of a polyester film were coated with a mixture of dyes in a styrene-acrylic resin (Joncryl 67 and 678, [trademark of S. C. Johnson]). In this preparation proprietary dye substances labeled I and II were dispersed together at a concentration of 0.5% w/v in a methyl ethyl ketone solution of resin (5% w/v). The coatings were accomplished by drawing down a film using a # 24 Meyer rod. Samples were air dried for 30 minutes before placement in a laboratory drying oven that was equilibrated at 105 C. Samples of film were harvested at 24 hour intervals and cut to an appropriate size for analysis using a PTI fluorimeter. The luminescence spectra recorded for samples obtained after three 24-hour heat treatment intervals are shown in FIG. 14 (untreated sample, upper left; sample after 3 days, lower right). Graph (a) shows both dyes (the one that absorbs at 612 nm and the one absorbing at 618 nm) at the beginning of the heat treatment process. Careful scrutiny showed that the dye, I, that emits with a peak at 612 nm is selectively degraded by heat treatment such that the sample after the 3-day trial corresponds to the emission of dye II (peak luminescence at 618 nm, lower right). Also noticeable was the change in luminescence decay time (inserts, FIG. 14); pre-treatment (FIG. 14a) lifetime readings having the shorter times associated with a combination of luminescence from the components, I and II, values after heat treatment corresponding to the lifetime of the dye II, alone (FIG. 14d), and intermediate lifetime readings for partially degraded samples.

### EXAMPLE 5

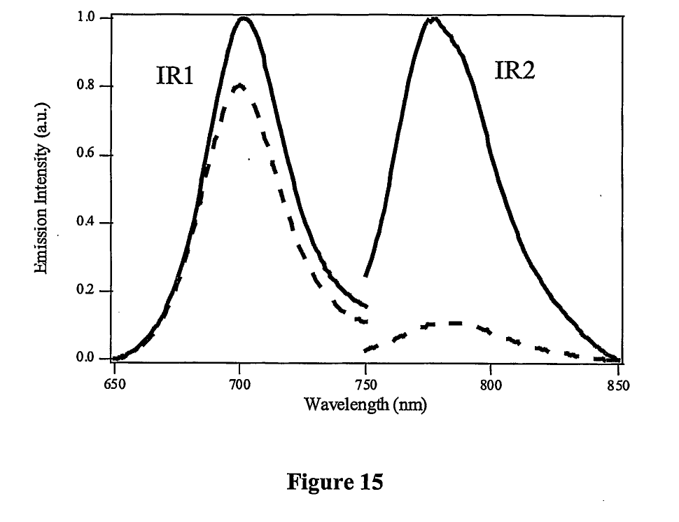

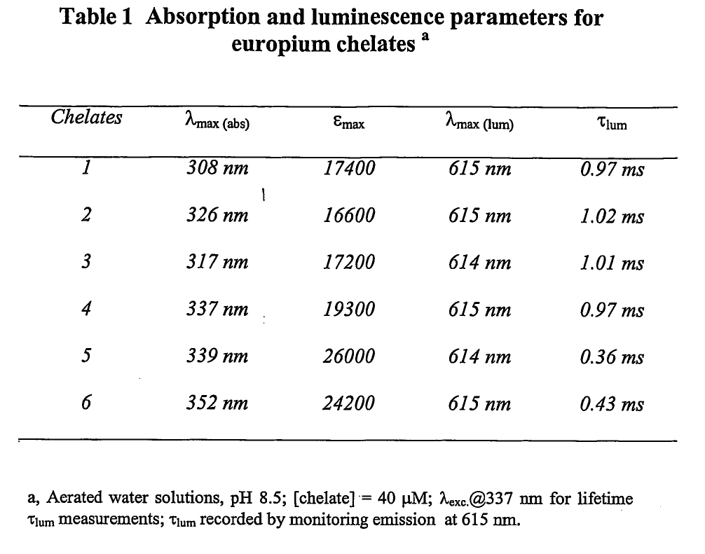

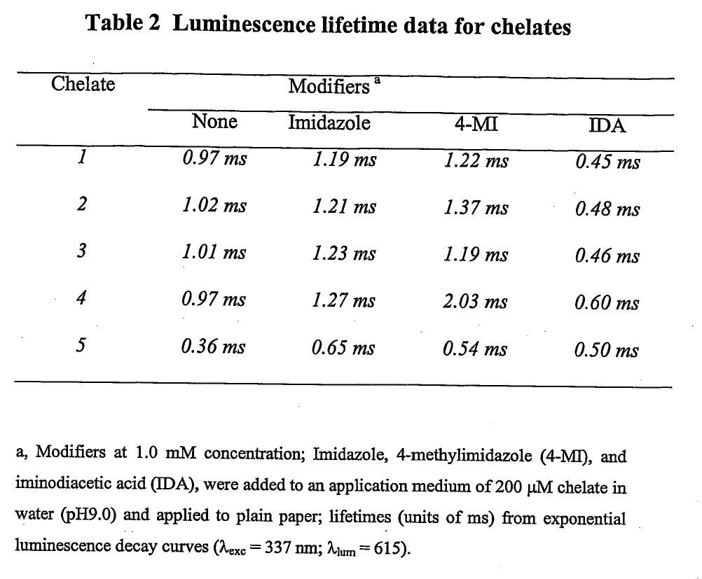

In this example, forensic IR dye samples were light treated. Proprietary infrared dyes, labeled IR1 and IR2 (40 micromolar concentration), were dissolved together in 50% v/v 2-propanol-water. The two-dye solution was irradiated using a 75 watt xenon lamp for 60 minutes. Emission spectra for the dye solutions were recorded using a PTI Time Master fluorimeter using excitation wavelengths of 650 nm and 690 nm for IR1 and IR2 dyes, respectively. The luminescence spectra are shown in FIG. 15, in which the solid lines correspond to emission of dye prior to the xenon lamp treatment and dashed lines represent dye luminescence after xenon lamp irradiation. The substantial photodegradation of IR2 compared to the behavior of IR1 was noted by recording the ratio of relative intensities measured at the luminescence maxima (light treated vs light untreated).

1. A system for product or document authentication, said system comprising:
a. one or more luminescent or fluorescent tags, said tags being applied to said product or document,
b. an optical scanning component for detecting a signal emitted by said tag, and
c. an information technology component for analyzing said signal.

2. The system of claim 1 wherein at least one of said tags has an emitted signal of known time resolution.

3. The system of claim 2 wherein said known time resolution is the time to decay to a predetermined value.

4. The system of claim 1 wherein at least one of said tags is a mixture of more than one compound.

5. The system of claim 2 wherein at least one of said tags is selected from the group consisting of dyes, inks and pigments.

6. The system of claim 4 wherein one of said tags is a mixture of a luminescent compound and a luminescence lifetime modifier.

7. The system of claim 6 wherein said luminescent compound is a lanthanide chelate.

8. The system of claim 2 wherein said known time resolution corresponds to an exponential, or sum of exponential, functions with decay constants (1/e) that fall in the time window of 1 microsecond to 1 second.

9. The system of claim 1 wherein said tag has characteristics that can be detected as an image, a wavelength, a decay time or a combination thereof.

10. The system of claim 1 wherein the substrate on which said tag is deposited is selected from the group consisting of paper, cloth, plastic, metal, leather, thread, metal or plastic foil, wrapping, coatings, films, holographic materials, label or card stock, printing inks, sprays, adhesives and glass.

11. The system of claim 1 wherein at least one of said tags is invisible to the human eye.

12. The system of claim 1 wherein one or more of said tags partially or completely overlaps another of said tags when applied to said product.

13. The system of claim 1 wherein said information technology component is capable of resolving the signal detected by said optical scanning system into components, each of which can be further analyzed.

14. The system of claim 13 wherein said further analysis comprises identification of the spectral characteristics of said component as a function of time.

15. The information technology component of claim 13 in which said further analysis also includes the determination of whether said tag is authentic.

16. The system of claim 1 in which said optical scanning component comprises a light source, tag, scanner, and information technology system.

17. The system of claim 1 in which said tags are applied at different times.

18. The system of claim 1 in which said tags are applied at the same time.

19. The system of claim 1 comprising two or more luminescent or fluorescent tags, at least one of said tags being a mixture of a lanthanide chelate and a luminescence lifetime modifier.

20. The system of claim 1 comprising two or more tags.

21. A system for product or document authentication, said system used to detect the presence of one or more luminescent or fluorescent dyes, wherein said dyes are applied to said product or document, and wherein said system comprises:
a. an optical scanning component for detecting signals emitted by said dyes, and
b. an information technology component for analyzing said signals.

22. The system of claim 21, wherein at least one of said tags is a mixture comprising a lanthanide chelate and a lifetime modifier selected from the group consisting of imidazoles, analogs of imidazole, derivatives of imidazole, phosphine oxide or pyridine oxides, polymers that provide coordination sites for metals, poly(vinyl acetate), poly(vinylpyrrolidinone), carboxylic acids, ketones, amides, alkene polymers, polyesters, and biopolymers.

23. The system of claim 21, wherein at least one of said tags has an emitted signal of known wavelength band and known decay time.

24. The system of claim 1 wherein the said tag is applied to a substrate using a method of printing, including ink jet, continuous ink jet, thermal transfer, pad, offset, gravure, flexographic, or screen printing.]

25. A method for authenticating a product or document, said method comprising:
a. labeling said product or document with one or more luminescent or fluorescent tags,
b. measuring the signals emitted from said tags using an optical scanning component, after said tags are illuminated with one or more appropriate energy sources, and
c. analyzing said signals using an information technology component.

26. The method of claim 25 in which at least one of said tags has an emitted signal of known time resolution.

27. The method of claim 25 in which the time for said tag to decay to a predetermined value is known.

28. The method of claim 25 in which at least one of said tags is invisible to the human eye.

29. A method for product or document authentication, said method being used to detect the presence of one or more luminescent or fluorescent dyes, wherein said dyes are applied to said product or document, and wherein said method comprises:
a. using an optical scanning component for detecting signals emitted by said dyes, and
b. using an information technology component for analyzing said signals.

30. A method for product or document authentication, said method being used to detect the presence of two or more dyes used as tags for said product or document, the combination of said dyes yielding a unique identifier, wherein said method comprises:
a. treating said tagged samples by exposing them to elevated temperature, electromagnetic radiation, or washing with selected solvents,
b. using an optical scanning component for detecting dye luminescence, and
c. comparing said dye luminescence detected vs. control samples treated by similar exposures to elevated temperature, electromagnetic radiation, or washing with selected solvents.

31. A method of claim 30 in which at least one of the said tags is a lanthanide chelate, based on the lanthanide elements, including but not limited to, europium, terbium, samarium, gadolinium, neodymium, and ytterbium.

32. A method of claim 30 in which at least one of the said tags is a near-infrared dye

33. A method of claim 30 in which the luminescence of dye tags is recorded using a spectrophotometer

34. A method of claim 30 in which the decay time of luminescence of dye tags is used to establish a comparison of treated and untreated samples

35. A method of claim 30 in which luminescence peak intensities for dye tags are used to establish a comparison of treated and untreated samples.

36. A method of claim 30 in which the dye tagged samples are heated in a drying oven before spectral analysis at 50-250 C.

37. A method of claim 30 in which dye tagged samples are irradiated before spectral analysis using lamps that include, but are not limited to, xenon, halogen, or mercury, or laser sources that include but are not limited to, solid state, Nd/YAG, dye, or nitrogen lasers.

38. A method of claim 30 in which dye tagged samples are washed before spectral analysis with solvent.

39. The method of claim 38 wherein said solvent is selected from the group consisting of acetone, tetrahydrofuran, chlorocarbon, ethyl acetate, toluene, dimethyl sulfoxide, dimethylformamide, water and mixtures thereof.

40. A composition of metal chelates in which the metal center is coordinated to one or more ligands that display charge transfer absorption bands.

41. A composition of chelates of claim 40 in which the metal center is a lanthanide element, including but not limited to the elements, europium, terbium, samarium, neodymium, gadolinium or ytterbium.

42. A composition of chelates of claim 40 in which the ligand is composed of aromatic rings having electron donating substituents.

43. The composition of claim 42 wherein said electron donating substituents are selected from the group consisting of —OH, —OR, —O⁻, —NH₂, —NR₂, —NHR, —CO₂⁻, —SO₃— and —SR.

44. A composition of chelates of claim 40 wherein said ligand is composed of aromatic rings having electron withdrawing groups.

45. The composition of claim 44 wherein said electron withdrawing groups are selected from the group consisting of nitro, quinone, sulfonyl groups, ketone, aldehyde, carboxyl, carboxylic acid derivatives, groups and halogens.

46. A method for forensic analysis comprising the method of claim 25, wherein said product or document is additionally treated with heat or light.

47. The system of claim 1 wherein the characteristics that can be modified in each of said tags is selected from the group consisting of (a) dye, pigment or ink, (b) size or shape, (c) position of one tag in relation to another, and (d) ability to change with time or when exposed to conditions such as heat, light or contact with a solvent.

48. The system of claim 16 wherein said optical scanning component utilizes photoexcitation created by one or more pulsed light sources.
